(19) United States
(12) Patent Application Publication
(10) Pub. No.: US 2015/0049953 A1
(43) Pub. Date: Feb. 19, 2015

(54) EMOTION AND APPEARANCE BASED SPATIOTEMPORAL GRAPHICS SYSTEMS AND METHODS

(71) Applicant: Emotient, San Diego, CA (US)

(72) Inventors: Javier MOVELLAN, La Jolla, CA (US); Josua SUSSKIND, La Jolla, CA (US)

(21) Appl. No.: 14/461,337

(22) Filed: Aug. 15, 2014

Related U.S. Application Data
(60) Provisional application No. 61/866,344, filed on Aug. 15, 2013.

(51) Int. Cl. G06K 9/00; H04N 7/18; G06K 9/32; G06K 9/20

(52) U.S. Cl. CPC G06K 9/00302; G06K 9/20; H04N 7/181; G06K 9/3233
USPC 382/197

(57) ABSTRACT

A computer-implemented method of mapping. The method includes analyzing images of faces in a plurality of pictures to generate content vectors, obtaining information regarding one or more vector dimensions of interest, at least some of the one or more dimensions of interest corresponding to facial expressions of emotion, and generating a representation of the location. Appearance of regions in the map varies in accordance with values of the content vectors for the one or more vector dimensions of interest. The method also includes using the representation, the step of using comprising at least one of storing, transmitting, and displaying.

### CROSS-REFERENCE TO RELATED APPLICATION

This application claims priority from U.S. provisional patent application Ser. No. 61/866,344, entitled EMOTION AND APPEARANCE BASED SPATIOTEMPORAL GRAPHICS SYSTEMS AND METHODS, filed on Aug. 15, 2013, Attorney Docket Reference MPT-1021-PV, which is hereby incorporated by reference in its entirety as if fully set forth herein, including text, figures, claims, tables, and computer program listing appendices (if present), and all other matter in the United States provisional patent application.

### FIELD OF THE INVENTION

This document relates generally to apparatus, methods, and articles of manufacture of mapping locations based on appearance and/or emotions of people in the areas.

### BACKGROUND

It is desirable to allow people easily to share feelings and emotions about locations/venues. It is also desirable to display information about people's emotions and appearances in a spatiotemporally organized manner.

### SUMMARY

Embodiments described in this document are directed to methods, apparatus, and articles of manufacture that may satisfy one or more of the foregoing and other needs.

In an embodiment, a computer-implemented method of mapping is provided. The method includes analyzing images of faces in a plurality of pictures to generate content vectors, obtaining information regarding one or more vector dimensions of interest, at least some of the one or more dimensions of interest corresponding to facial expressions of emotion, and generating a representation of the location. An appearance of regions in the map varies in accordance with values of the content vectors for the one or more vector dimensions of interest. The method also includes using the representation, for example by storing, transmitting, and displaying.

In an embodiment, a computer-based system is configured to perform mapping. The mapping may be performed by steps including analyzing images of faces in a plurality of pictures to generate content vectors, obtaining information regarding one or more vector dimensions of interest, at least some of the one or more dimensions of interest corresponding to facial expressions of emotion, and generating a representation of the location. An appearance of regions in the map varies in accordance with values of the content vectors for the one or more vector dimensions of interest. The method also includes using the representation, for example by storing, transmitting, and displaying.

In an embodiment, an article of manufacture including non-transitory machine-readable memory is embedded with computer code of a computer-implemented method of mapping. The method includes analyzing images of faces in a plurality of pictures to generate content vectors, obtaining information regarding one or more vector dimensions of interest, at least some of the one or more dimensions of interest corresponding to facial expressions of emotion, and generating a representation of the location. An appearance of regions in the map varies in accordance with values of the content vectors for the one or more vector dimensions of interest. The method also includes using the representation, for example by storing, transmitting, and displaying.

In an embodiment, the plurality of images may be received from a plurality of networked camera devices. Example of the location includes but are not limited to a geographic area or an interior of a building.

In an embodiment, the representation includes a map and a map overlay of the location. Colors in the map overlay may indicate at least one emotion or human characteristic indicated by the values of the content vectors for the one or more vector dimensions of interest. The map and map overlay may be zoom-able. More or less details in the overlay may be shown in response to zooming in or out.

These and other features and aspects of the present invention will be better understood with reference to the following description, drawings, and appended claims.

### BRIEF DESCRIPTION OF THE FIGURES

FIG. 1 is a simplified block diagram illustrating selected blocks of a computer-based system configured in accordance with selected aspects of the present description; and

FIG. 2 illustrates selected steps/blocks of a process in accordance with selected aspects of the present description.

FIG. 3 illustrates an example of an emotional and appearance based spatiotemporal “heat” map in a retail context in accordance with selected aspects of the present description.

FIG. 4 illustrates an example of an emotional and appearance based spatiotemporal “heat” map in a street map context in accordance with selected aspects of the present description.

FIG. 5 illustrates an example of an emotional and appearance based spatiotemporal “heat” map in a zoomed-in street map context in accordance with selected aspects of the present description.

### DETAILED DESCRIPTION

In this document, the words “embodiment,” “variant,” “example,” and similar expressions refer to a particular apparatus, process, or article of manufacture, and not necessarily to the same apparatus, process, or article of manufacture. Thus, “one embodiment” (or a similar expression) used in one place or context may refer to a particular apparatus, process, or article of manufacture; the same or a similar expression in a different place or context may refer to a different apparatus, process, or article of manufacture. The expression “alternative embodiment” and similar expressions and phrases may be used to indicate one of a number of different possible embodiments. The number of possible embodiments/variants/examples is not necessarily limited to two or any other quantity. Characterization of an item as “exemplary,” means that the item is used as an example. Such characterization of an embodiment/variant/example does not necessarily mean that the embodiment/variant/example is a preferred one; the embodiment/variant/example may but need not be a currently preferred one. All embodiments/variants/examples are described for illustration purposes and are not necessarily strictly limiting.

The words “couple,” “connect,” and similar expressions with their inflectional morphemes do not necessarily import an immediate or direct connection, but include within their meaning connections through mediate elements.

“Facial expressions” as used in this document signifies the primary facial expressions of emotion (such as Anger, Contempt, Disgust, Fear, Happiness, Sadness, Surprise, Neutral); expressions of affective state of interest (such as boredom, interest, engagement, confusion, frustration); so-called “facial action units” (movements of a subset of facial muscles, including movement of individual muscles, such as the action units used in the Facial Action Coding System or FACS); and gestures/poses (such as tilting head, raising and lowering eyebrows, eye blinking, nose wrinkling, chin supported by hand).

“Human appearance characteristic” includes facial expressions and additional appearance features, such as ethnicity, gender, attractiveness, apparent age, and stylistic characteristics (including clothing styles such as jeans, skirts, jackets, ties; shoes; and hair styles).

“Low level features” are low level in the sense that they are not attributes used in everyday life language to describe facial information, such as eyes, chin, cheeks, brows, forehead, hair, nose, ears, gender, age, ethnicity, etc. Examples of low level features include Gabor orientation energy, Gabor scale energy, Gabor phase, and Haar wavelet outputs.

Automated facial expression recognition and related subject matter are described in a number of commonly-owned patent applications, including (1) application entitled SYSTEM FOR COLLECTING MACHINE LEARNING TRAINING DATA FOR FACIAL EXPRESSION RECOGNITION, by Javier R. Movellan, et al., Ser. No. 61/762,820, filed on or about 8 Feb. 2013, attorney docket reference MPT-1010-PV; (2) application entitled ACTIVE DATA ACQUISITION FOR DEVELOPMENT AND CONTINUOUS IMPROVEMENT OF MACHINE PERCEPTION SYSTEMS, by Javier R. Movellan, et al., Ser. No. 61/763,431, filed on or about 11 Feb. 2013, attorney docket reference MPT-1012-PV; (3) application entitled EVALUATION OF RESPONSES TO SENSORY STIMULI USING FACIAL EXPRESSION RECOGNITION, Javier R. Movellan, et al., Ser. No. 61/763,657, filed on or about 12 Feb. 2013, attorney docket reference MPT-1013-PV; (4) application entitled AUTOMATIC FACIAL EXPRESSION MEASUREMENT AND MACHINE LEARNING FOR ASSESSMENT OF MENTAL ILLNESS AND EVALUATION OF TREATMENT, by Javier R. Movellan, et al., Ser. No. 61/763,694, filed on or about 12 Feb. 2013, attorney docket reference MPT-1014-PV; (5) application entitled ESTIMATION OF AFFECTIVE VALENCE AND AROUSAL WITH AUTOMATIC FACIAL EXPRESSION MEASUREMENT, Ser. No. 61/764,442, filed on or about 13 Feb. 2013, Attorney Docket Reference MPT-1016-PV, by Javier R. Movellan, et al.; (6) application entitled FACIAL EXPRESSION TRAINING USING FEEDBACK FROM AUTOMATIC FACIAL EXPRESSION RECOGNITION, Attorney Docket Number MPT-1017-PV, filed on or about 15 Feb. 2013, by Javier R. Movellan, et al., Ser. No. 61/765,570; and (7) application entitled QUALITY CONTROL FOR LABELING MACHINE LEARNING TRAINING EXAMPLES, Ser. No. 61/765,671, filed on or about 15 Feb. 2013, Attorney Docket Reference MPT-1015-PV, by Javier R. Movellan, et al; (8) application entitled AUTOMATIC ANALYSIS OF NON-VERBAL RAPPORT, Ser. No. 61/766,866, filed on or about 20 February 2013, Attorney Docket Reference MPT-1018-PV2, by Javier R. Movellan, et al; and (9) application entitled SPATIAL ORGANIZATION OF IMAGES BASED ON EMOTION FACE CLOUDS, Ser. No. 61/831,610, filed on or about 5 Jun. 2013, Attorney Docket Reference MPT-1022, by Javier R. Movellan, et al. Each of these provisional applications is incorporated herein by reference in its entirety, including claims, tables, computer code and all other matter in the patent applications.

Other and further explicit and implicit definitions and clarifications of definitions may be found throughout this document.

Reference will be made in detail to several embodiments that are illustrated in the accompanying drawings. Same reference numerals are used in the drawings and the description to refer to the same apparatus elements and method steps. The drawings are in a simplified form, not to scale, and omit apparatus elements and method steps that can be added to the described systems and methods, while possibly including certain optional elements and steps.

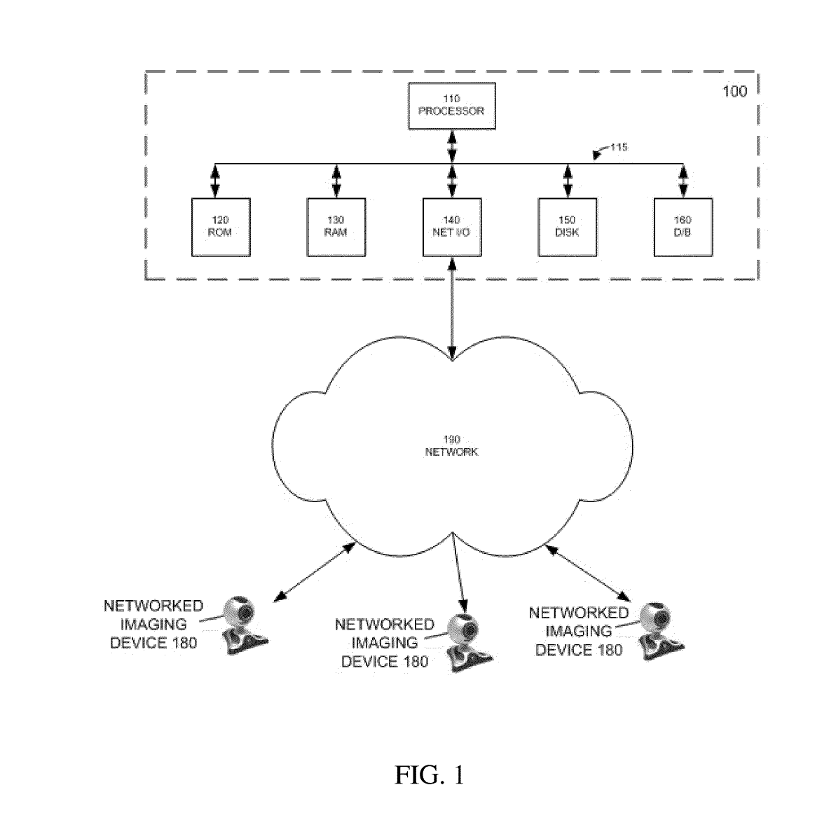

FIG. 1 is a simplified block diagram representation of a computer-based system 100, configured in accordance with selected aspects of the present description to collect spatio-temporal information about people in various locations, and to use the information for mapping, searching, and/or other purposes. The system 100 interacts through a communication network 190 with various networked camera devices 180, such as webcams, camera-equipped desktop and laptop personal computers, camera-equipped mobile devices (e.g., tablets and smartphones), and wearable device (e.g., Google Glass and similar products, particularly products for vehicular applications with camera(s) trained on driver(s) and/or passenger(s)). FIG. 1 does not show many hardware and software modules of the system 100 and of the camera devices 180, and omits various physical and logical connections. The system 100 may be implemented as a special purpose data processor, a general-purpose computer, a computer system, or a group of networked computers or computer systems configured to perform the steps of the methods described in this document. In some embodiments, the system 100 is built on a personal computer platform, such as a Wintel PC, a Linux computer, or a Mac computer. The personal computer may be a desktop or a notebook computer. The system 100 may function as one or more server computers. In some embodiments, the system 100 is implemented as a plurality of computers interconnected by a network, such as the network 190, or another network.

As shown in FIG. 1, the system 100 includes a processor 110, read only memory (ROM) module 120, random access memory (RAM) module 130, network interface 140, a mass storage device 150, and a database 160. These components are coupled together by a bus 115. In the illustrated embodiment, the processor 110 may be a microprocessor, and the mass storage device 150 may be a magnetic disk drive. The mass storage device 150 and each of the memory modules 120 and 130 are connected to the processor 110 to allow the processor 110 to write data into and read data from these storage and memory devices. The network interface 140 couples the processor 110 to the network 190, for example, the Internet. The nature of the network 190 and of the devices that may be interposed between the system 100 and the network 190 determine the kind of network interface 140 used in the system 100. In some embodiments, for example, the network interface 140 is an Ethernet interface that connects the system 100 to a local area network, which, in turn, connects to the Internet. The network 190 may therefore be a combination of several networks.

The database 160 may be used for organizing and storing data that may be needed or desired in performing the method steps described in this document. The database 160 may be a physically separate system coupled to the processor 110. In alternative embodiments, the processor 110 and the mass storage device 150 may be configured to perform the functions of the database 160.

The processor 110 may read and execute program code instructions stored in the ROM module 120, the RAM module 130, and/or the storage device 150. Under control of the program code, the processor 110 may configure the system 100 to perform the steps of the methods described or mentioned in this document. In addition to the ROM/RAM modules 120/130 and the storage device 150, the program code instructions may be stored in other machine-readable storage media, such as additional hard drives, floppy diskettes, CD-ROMs, DVDs, Flash memories, and similar devices. The program code may also be transmitted over a transmission medium, for example, over electrical wiring or cabling, through optical fiber, wirelessly, or by any other form of physical transmission. The transmission can take place over a dedicated link between telecommunication devices, or through a wide area or a local area network, such as the Internet, an intranet, extranet, or any other kind of public or private network. The program code may also be downloaded into the system 100 through the network interface 140 or another network interface.

The camera devices 180 may be operated exclusively for the use of the system 100 and its operator, or be shared with other systems and operators. The camera devices 180 may be distributed in various geographic areas/venues, outdoors and/or indoors, in vehicles, and/or in other structures, whether permanently stationed, semi-permanently stationed, and/or readily movable. The camera devices 180 may be configured to take pictures on demand and/or automatically, at predetermined times and/or in response to various events. The camera devices 180 may have the capability to “tag” the pictures they take with location information, e.g., global positioning system (GPS) data; with time information (the time when each picture was taken); and camera orientation information (the direction into which the camera device 180 is facing when taking the particular picture). The system 100 may also have information regarding the location and direction of the camera devices 180 and thus inherently have access to the direction and location “tags” for the pictures received from specific camera devices 180. Further, if the system 100 receives the pictures from a particular camera device 180 substantially in real time (say, within ten seconds, a minute, an hour, or even three-hour time period), the system 100 then inherently also have time “tags” for the pictures.

The system 100 may receive tagged (explicitly and/or inherently) pictures from the camera devices 180, and then process the pictures to identify facial expressions and other human appearance characteristics, using a variety of classifiers, as is described in the patent applications identified above and incorporated by reference in this document. The outputs of the classifiers resulting from processing of a particular picture result in a vector of the classifier output values in a particular (predetermined) order of classifiers. Each picture is thus associated with an ordered vector of classifier values. The classifiers may be configured and trained to produce a signal output in accordance with the presence or absence of a particular emotion displayed by the face (or faces, as the case may be) in the picture, action unit, and/or low level feature. Each of the classifiers may be configured and trained for a different emotion, including, for example, the seven primary emotions (Anger, Contempt, Disgust, Fear, Happiness, Sadness, Surprise), as well as neutral expressions, and expression of affective state of interest (such as boredom, interest, engagement). Another classifier may be configured two produce an output based on the number of faces in a particular picture. Additional classifiers may be configured and trained to produce signal outputs corresponding to other human appearance characteristics. We have described certain aspects of such classifiers in the patent applications listed and incorporated by reference above.

Thus, the pictures may be processed for finding persons and faces. The pictures may then be processed to estimate demographics of the persons in the pictures (e.g., age, ethnicity, gender); to estimate facial expression of the person (e.g., primary emotions, interest, frustration, confusion). The pictures may be further processed using detectors/classifiers tuned to specific trends to characterize hair styles (e.g., long hair, military buzz cuts, bangs) and clothing styles (e.g., jeans, skirts, jackets) of the persons in the pictures.

In variants, the pictures from the camera devices 180 are processed by the camera devices 180 themselves, or by still other devices/servers, and the system 100 receives the vectors associated with the pictures. The system 100 may receive the vectors without the pictures, the vectors and the pictures, or some combination of the two, that is, some vectors with their associated pictures, some without. Also, the processing may be split between or among the system 100, the camera devices 180, and/or the other devices, with the pictures being processed in two or more types of these devices, to obtain the vectors.

In the system 100, the vectors of the pictures may be stored in the database 160, and/or in other memory/storage devices of the system 100 (e.g., the mass storage device 150, the memory modules 120/130).

The system 100 may advantageously be configured (e.g., by the processor 110 executing appropriate code) to collect space and time information and display statistics of selected (target) dimensions of the picture vectors organized in space and time, to use the vectors to allow people to share feelings and emotions about locations, to display information about emotions and other human appearance characteristics in a spatiotemporally organized manner, and to allow users to navigate in space and time and to display different vector dimensions. Thus, the system 100 may be configured to generate maps for different dimensions of the picture vectors and aggregate variables (e.g., the frequency of people with a particular hair style, frequency of people with the trendiest or other styles of clothes). The maps may be in two or three dimensions, may cover indoor and/or outdoor locations, and be displayed in a navigable and zoom-able manner, for example, analogously to Google Maps or Google Earth. The system 100 may also be configured to project the spatiotemporally organized information onto a map generated by Google Maps, Google Earth, or a similar service.

In some embodiments, a map may show sentiment analysis across the entire planet. Zooming in onto the map may show more detailed sentiment analysis for increasingly small areas. For example, zooming in may permit a user to see sentiment analysis across a country, a region in the country, a city in the region, a neighborhood in the city, a part of the neighborhood, a particular location in the neighborhood such as a store, park, or recreational facility, and then a particular part of that location. Zooming out may result in the reverse of this progression. The present invention is not limited to this capability or to these examples.

A user interface may be implemented to allow making of spatiotemporal queries, such as queries to display the happiest places, display area in San Diego or another geographic area where the trendiest clothing is observed, display times in a shopping center or another pre-specified type of venue with the most people observed with particular emotion(s) (e.g., happiness, surprise, amusement, interest), display ethnic diversity maps. The interface may also be configured to allow the user to filter the picture vector data based on friendship and similarity relationships. For example, the user may be enabled to request (through the interface) a display of locations which people similar to the user liked or where such people were most happy.

Here, similarity may be based on demographics or other human appearance characteristics that may be identified or estimated from the pictures. Thus, a twenty-something user A may employ the interface to locate venues where people of his or her approximate age tend to smile more often than in other venues of the same or different type. User A may not care about places where toddlers, kindergartners, and senior citizens smile, and specify his or her preference through the interface. Furthermore, the system 100 may be configured automatically to tailor its displays to the particular user. Thus, based on the knowledge of the user's demographics and/or other characteristics and preferences, however obtained (for example, through the user registration process or based on the previously expressed preferences of the user), the system may automatically focus on the vectors of the pictures with similar demographics/characteristics/preferences, and omit the vectors of the pictures without sufficiently similar persons.

The searches and map displays may be conditioned by the time of day, and/or specific dates. Thus, the user may specify a display of a map of people similar to the user with happy emotion between specific times, for example, during happy hour on Friday evenings. In variants, the user may ask for a color or shaded display with different colors/shades indicating the relative incidences of the searched vector dimensions. In variants, the user may ask the system to play the map as it changes over time; for example, the user may use the interface to specify a display of how the mood of people similar to the user changes between 6 pm and 9 pm in a particular bar. The system 100 may “play” the map at an accelerated pace, or allow the user to play the map as the user desires, for example, by moving a sliding control from 6 pm to 9 pm.

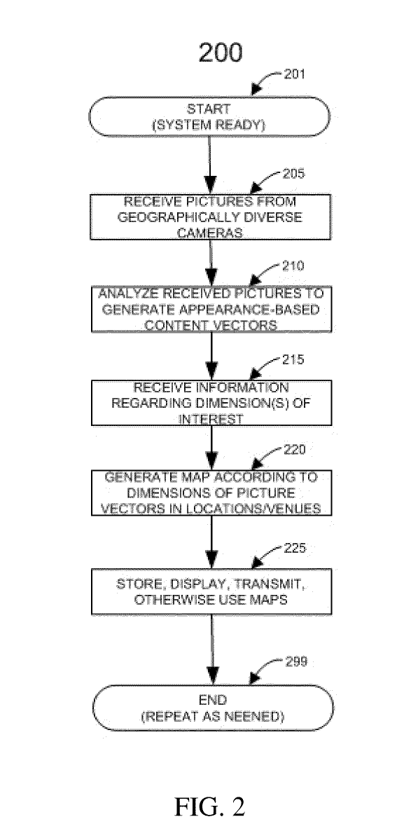

FIG. 2 illustrates selected steps of a process 200 for generating and displaying (or otherwise using) a spatiotemporal map.

At flow point 201, the system 100 is powered up and configured to perform the steps of the process 200.

In step 205, the system 100 receives through a network pictures from the devices 180.

In step 210, the system 100 analyzes the received pictures for the emotional content and/or other content in each of the pictures, e.g., human appearance characteristics, action units, and/or low level features. For example, each of the pictures may be analyzed by a collection of classifiers of facial expressions, action units, and/or low level features. Each of the classifiers may be configured and trained to produce a signal output in accordance with the presence or absence of a particular emotion or other human appearance characteristic displayed by the face (or faces, as the case may be) in the picture, action unit, or low level feature. Each of the classifiers may be configured and trained for a different emotion/characteristic, including, for example, the seven primary emotions (Anger, Contempt, Disgust, Fear, Happiness, Sadness, Surprise), as well as neutral expressions, and expression of affective state of interest (such as boredom, interest, engagement). Additional classifiers may be configured and trained to produce signal output corresponding to other human appearance characteristics, which are described above. For each picture, a vector of ordered values of the classifiers is thus obtained. The vectors are stored, for example, in the database 160.

In step 215, the system obtains information regarding the dimension(s) of interest for a particular task (which here includes a particular search and/or generation of a map or a map overlay to be displayed, based on some appearance-related criteria or criterion of the pictures). The dimension(s) may be based on the user parameters supplied specifically for the task by the user, for example, provided by the user explicitly for the task, and/or at a previous time (e.g., during registration, from a previous task, otherwise). The dimension(s) may also be based on some predetermined default parameters. The dimension(s) may be classifier outputs for one or more emotions and/or other human appearance characteristics.

In step 220, the system 100 generates a map or a map overlay where appearance of different geographic locations and/or venues is varied in accordance with the dimension(s) of interest of the vectors in the locations/venues. For example, the higher the average happy dimension for faces in the pictures (or for faces in the pictures estimated to be belong to people similar to the user, such as within the same age cohort as the user, say within the same decade), the more intensity is conveyed by the color or shading, and vice versa. Several maps or map overlays may be generated, for example, for different times.

In step 225, the system 100 stores, transmits, displays, and/or otherwise uses the map or maps.

The process 200 terminates in flow point 299, to be repeated as needed.

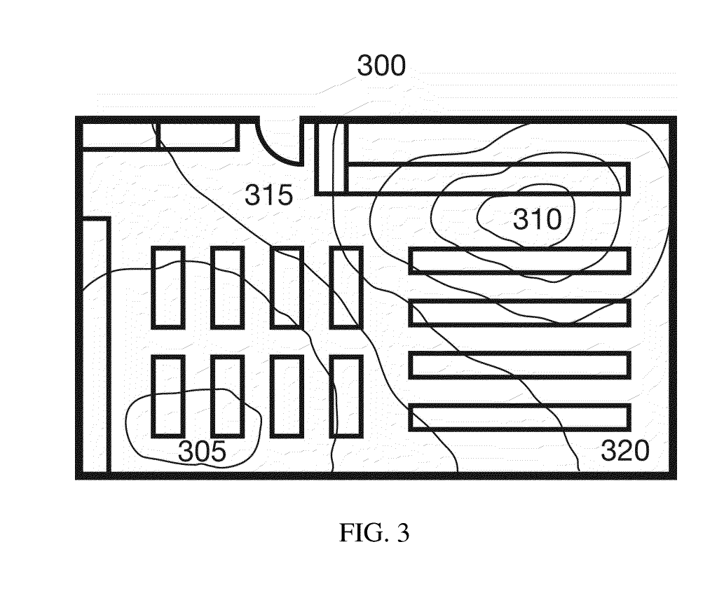

FIG. 3 illustrates an example of an emotional and appearance based spatiotemporal map in a retail context in accordance with selected aspects of the present description. This map may be displayed by a system such as system 100 in FIG. 1. Map 300 in FIG. 3 shows sentiment analysis of a retail environment illustrated in a nature akin to a heat map. Different areas in the map may be shaded or colored to represent various levels of one or more particular emotions or other human appearance characteristics displayed by faces in images captured in that retail environment. For example, area 310 may indicate where the happiest facial expressions of emotions were detected, area 305 map indicate where the least happy facial expressions of emotions were detected, and areas 315 and 320 may indicate where intermediate facial expressions of happiness were detected.

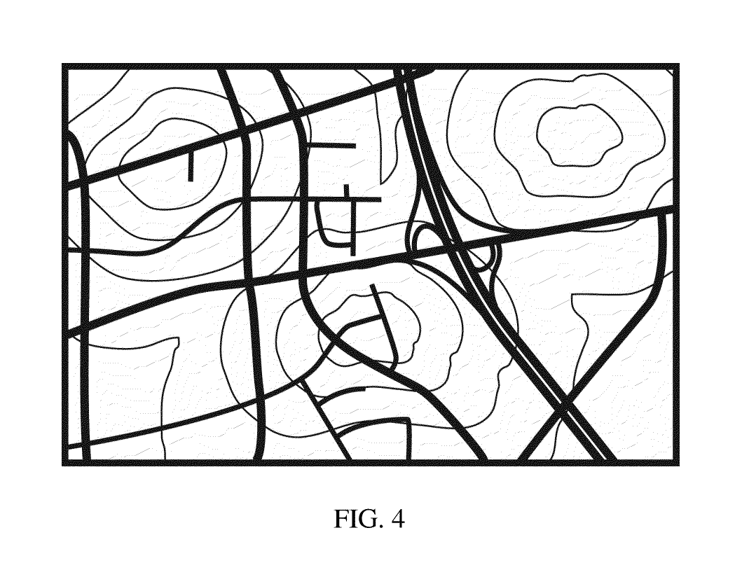

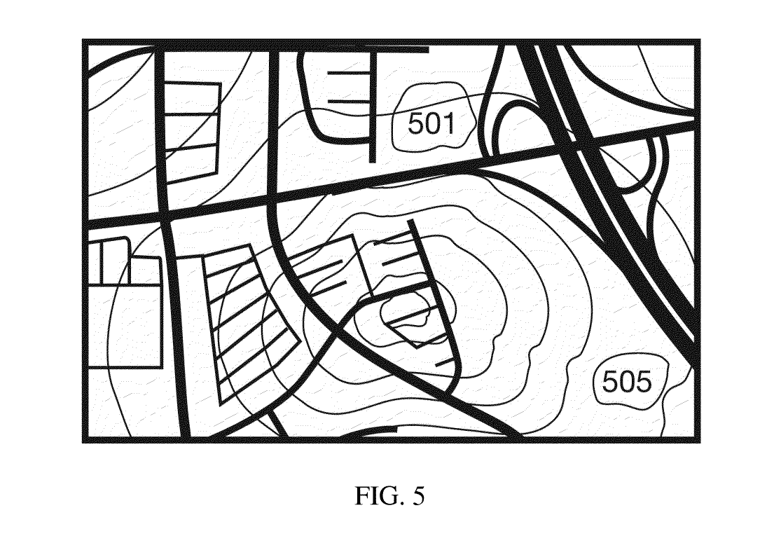

FIG. 4 illustrates an example of an emotional and appearance based spatiotemporal map in a street map context. This map is zoom-able. FIG. 5 illustrates an example of a zoomed in portion of the map in FIG. 4. More detailed sentiment analysis may be provided in the zoomed-in map. Thus, the map in FIG. 5 shows additional detail 501 and 505 not shown in FIG. 4.

In some embodiments, various color schemes may be used to indicate the emotions or other characteristics. For example, blue may represent happiness and red may represent unhappiness. Different levels of happiness or unhappiness may be represented by different intensities of coloring, by using intermediate colors, or in some other manner. A scale may be provided to indicate how the colors correlate to an emotion or human characteristic. Preferably, the color scheme is selected to provide intuitive indications of the emotion or human characteristic.

In some embodiments, a sentiment analysis map may be based on images captured during a particular time frame, aggregated over time, or selected in some other manner. The sentiment analysis may be for a fixed time, a selectable time frame, or a moving time frame that may be updated in real time.

In some embodiments, a sentiment analysis map may represent the particular emotion or characteristics for all people, some demographic of people (e.g., gender, ethnicity, age, etc.), people dressed in a particular fashion, or some other group of people. A legend or caption may be displayed with the map to indicate the relevant time frame, demographic information, and/or other relevant information.

In some embodiments, a sentiment analysis map may indicate the emotion or human characteristic in some other fashion than shown in FIGS. 3, 4, and 5. For example, lines representing people moving through a space may be colored to indicate one or more emotions or human characteristics. For another example, dots representing people who stay in place for some period of time may be colored to indicate that the person's face displayed a particular emotion or human characteristic. The present invention is not limited to any of these examples.

The present invention may have applicability in many different contexts besides those illustrated in FIGS. 3, 4, and 5. Examples include but are not limited to sentiment analysis on museums, sentiment analysis in different classrooms in a school, sentiment analysis on interiors of any other buildings, sentiment analysis of different parts of a city, sentiment analysis across or among different cities, sentiment analysis on roadways (e.g., to detect areas that are likely to engender road rage), and the like.

The system and process features described throughout this document may be present individually, or in any combination or permutation, except where presence or absence of specific feature(s)/element(s)/limitation(s) is inherently required, explicitly indicated, or otherwise made clear from the context.

Although the process steps and decisions (if decision blocks are present) may be described serially in this document, certain steps and/or decisions may be performed by separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific embodiments/variants/examples use the particular order(s) in which the steps and decisions (if applicable) are shown and/or described.

The instructions (machine executable code) corresponding to the method steps of the embodiments, variants, and examples disclosed in this document may be embodied directly in hardware, in software, in firmware, or in combinations thereof. A software module may be stored in volatile memory, flash memory, Read Only Memory (ROM), Electrically Programmable ROM (EPROM), Electrically Erasable Programmable ROM (EEPROM), hard disk, a CD-ROM, a DVD-ROM, or other form of non-transitory storage medium known in the art, whether volatile or non-volatile. Exemplary storage medium or media may be coupled to one or more processors so that the one or more processors can read information from, and write information to, the storage medium or media. In an alternative, the storage medium or media may be integral to one or more processors.

This document describes in detail the inventive apparatus, methods, and articles of manufacture for spatiotemporal mapping and searching. This was done for illustration purposes only. The specific embodiments or their features do not necessarily limit the general principles underlying the disclosure of this document. The specific features described herein may be used in some embodiments, but not in others, without departure from the spirit and scope of the invention(s) as set forth herein. Various physical arrangements of components and various step sequences also fall within the intended scope of the disclosure. Many additional modifications are intended in the foregoing disclosure, and it will be appreciated by those of ordinary skill in the pertinent art that in some instances some features will be employed in the absence of a corresponding use of other features. The illustrative examples therefore do not necessarily define the metes and bounds of the invention(s) and the legal protection afforded the invention(s).

What is claimed is:

1. A computer-implemented method of mapping, the method comprising steps of:
analyzing images of faces in a plurality of pictures to generate content vectors;
obtaining information regarding one or more vector dimensions of interest, at least some of the one or more dimensions of interest corresponding to facial expressions of emotion;
generating a representation of the location, wherein an appearance of regions in the map varies in accordance with values of the content vectors for the one or more vector dimensions of interest; and
using the representation, the step of using comprising at least one of storing, transmitting, and displaying.

2. A computer-implemented method according to claim 1, further comprising receiving the plurality of images from a plurality of networked camera devices.

3. A computer-implemented method according to claim 1, wherein the location comprises a geographic area or an interior of a building.

4. A computer-implemented method according to claim 1, wherein the representation comprises a map and a map overlay of the location.

5. A computer-implemented method according to claim 4, wherein colors in the map overlay indicate at least one emotion or human characteristic indicated by the values of the content vectors for the one or more vector dimensions of interest.

6. A computer-implemented method according to claim 5, wherein the map and map overlay are zoom-able, and further comprising showing more or less details in the overlay in response to zooming in or out.

7. A computer-based system configured to perform steps comprising:
analyzing images of faces in a plurality of pictures to generate content vectors;
obtaining information regarding one or more vector dimensions of interest, at least some of the one or more dimensions of interest corresponding to facial expressions of emotion;
generating a representation of the location, wherein an appearance of regions in the map varies in accordance with values of the content vectors for the one or more vector dimensions of interest; and
using the representation, the step of using comprising at least one of storing, transmitting, and displaying.

8. A computer-based system according to claim 7, wherein the steps further comprise receiving the plurality of images from a plurality of networked camera devices.

9. A computer-based system according to claim 7, wherein the location comprises a geographic area or an interior of a building.

10. A computer-based system according to claim 7, wherein the representation comprises a map and a map overlay of the location.

11. A computer-based system according to claim 10, wherein colors in the map overlay indicate at least one emotion or human characteristic indicated by the values of the content vectors for the one or more vector dimensions of interest.

12. A computer-based system according to claim 11, wherein the map and map overlay are zoom-able, and wherein the steps further comprise showing more or less details in the overlay in response to zooming in or out.

13. An article of manufacture comprising non-transitory machine-readable memory embedded with computer code of a computer-implemented method of mapping, the method comprising steps of:
analyzing images of faces in a plurality of pictures to generate content vectors;
obtaining information regarding one or more vector dimensions of interest, at least some of the one or more dimensions of interest corresponding to facial expressions of emotion;
generating a representation of the location, wherein an appearance of regions in the map varies in accordance with values of the content vectors for the one or more vector dimensions of interest; and
using the representation, the step of using comprising at least one of storing, transmitting, and displaying.

14. An article of manufacture according to claim 13, wherein the method further comprises receiving the plurality of images from a plurality of networked camera devices.

15. An article of manufacture according to claim 13, wherein the location comprises a geographic area or an interior of a building.

16. An article of manufacture according to claim 13, wherein the representation comprises a map and a map overlay of the location.

17. An article of manufacture according to claim 16, wherein colors in the map overlay indicate at least one emotion or human characteristic indicated by the values of the content vectors for the one or more vector dimensions of interest.

18. An article of manufacture according to claim 17, wherein the map and map overlay are zoom-able, and wherein the method further comprises showing more or less details in the overlay in response to zooming in or out.
